(19) United States
(12) Patent Application Publication
(10) Pub. No.: US 2022/0294606 A1
(43) Pub. Date: Sep. 15, 2022

(54) METHODS, APPARATUS AND MACHINE-READABLE MEDIA RELATING TO MACHINE-LEARNING IN A COMMUNICATION NETWORK

(71) Applicant: Telefonaktiebolaget LM Ericsson (publ), Stockholm (SE)

(72) Inventors: Karl NORRMAN, Stockholm (SE); Martin ISAKSSON, Stockholm (SE)

(21) Appl. No.: 17/635,400

(22) PCT Filed: Aug. 6, 2020
(86) PCT No.: PCT/EP2020/072118

§ 371 Date: Feb. 15, 2022

Related U.S. Application Data
(60) Provisional application No. 62/887,844, filed on Aug. 16, 2019.

(51) Int. Cl. H04L 9/08; G06N 20/00; H04L 9/30

(52) U.S. Cl. CPC H04L 9/088; G06N 20/00; H04L 9/30

(57) ABSTRACT

A method performed by a first entity in a communications network is provided. The first entity belongs to a plurality of entities configured to perform federated learning to develop a model. In the method, the first entity trains a model using a machine-learning algorithm, generating a model update. The first entity generates a first mask, receives an indication of one or more respective second masks from a subset of the remaining entities of the plurality of entities, and combines the first mask and the respective second masks to generate a combined mask. The first entity transmits an indication of the first mask to one or more third entities of the plurality of entities. The first entity applies the combined mask to the model update to generate a masked model update and transmits the masked model update to an aggregating entity of the communications network.

### TECHNICAL FIELD

Embodiments of the disclosure relate to machine learning, and particularly to methods, apparatus and machine-readable media relating to machine-learning in a communication network.

### BACKGROUND

In a typical wireless communication network, wireless devices are connected to a core network via a radio access network. In a fifth generation (5G) wireless communication network, the core network operates according to a Service Based Architecture (SBA), in which services are provided by network functions via defined application interfaces (APIs). Network functions in the core network use a common protocol framework based on Hypertext Transfer Protocol 2 (HTTP/2). As well as providing services, a network function can also invoke services in other network functions through these APIs. Examples of core network functions in the 5G architecture include the Access and mobility Management Function (AMF), Authentication Server Function (AUSF), Session Management Function (SMF), Policy Charging Function (PCF), Unified Data Management (UDM) and Operations, Administration and Management (OAM). For example, an AMF may request subscriber authentication data from an AUSF by calling a function in the API of an AUSF for this purpose.

Efforts are being made to automate 5G networks, with the aim of providing fully automated wireless communication networks with zero touch (i.e. networks that require as little human intervention during operation as possible). One way of achieving this is to use the vast amounts of data collected in wireless communication networks in combination with machine-learning algorithms to develop models for use in providing network services.

A Network Data Analytics (NWDA) framework has been established for defining the mechanisms and associated functions for data collection in 5G networks. Further enhancements to this framework are described in the 3GPP document TS 23.288 v 16.0.0. The NWDA framework is centred on a Network Data Analytics Function (NWDAF) that collects data from other network functions in the network. The NWDAF also provides services to service consumers (e.g. other network functions). The services include, for example, retrieving data or making predictions based on data collated at the NWDAF.

FIG. 1 shows an NWDAF 102 connected to a network function (NF) 104. As illustrated, the network function 104 may be any suitable network function (e.g. an AMF, an AUSF or any other network function). Here we note that the term “network function” is not restricted to core network functions, and may additionally relate to functions or entities in the radio access network or other parts of the communication network. In order to collect data from the network function 104, the NWDAF 102 connects to an Event Exposure Function at the network function over an Nnf reference point (as detailed in the 3GPP documents TS 23.502 v 16.0.2 and TS 23.288, v 16.0.0). The NWDAF 102 can then receive data from the network function over the Nnf reference point by subscribing to reports from the network function or by requesting data from the network function. The timing of any reports may be determined by timeouts (e.g. expiry of a timer) or may be triggered by events (e.g. receipt of a request). The types of data that can be requested by the NWDAF 102 from the network function may be standardised.

FIG. 2 shows an NWDAF 204 connected to a NWDAF Service Consumer 202. The NWDAF 204 exposes information relating to the collected data over the Nnwdaf reference point. Thus the NWDAF Service Consumer 202 (which may be any network function or entity authorised to access the data) subscribes to receive analytics information or data from the NWDAF 204 and this is acknowledged. Thereafter, the NWDAF 204 may transmit or expose reports on collected data to the NWDAF Service Consumer 202. The timing of any reports may again be determined by timeouts (e.g. expiry of a timer) or may be triggered by events (e.g. receipt of a request). The NWDAF Service Consumer 202 may similar unsubscribe from the analytics information.

### SUMMARY

As noted above, data collection has the potential to be a powerful tool for 5G networks when coupled with machine-learning. Machine-learning in the context of 5G networks is large-scale and may be executed in a cloud (virtualised) environment where performance and security are prioritised. In practice, this means that the data available for training models using machine-learning may be distributed across many entities in the network, which means that data should ideally be collated at one network entity to be used for developing models using machine-learning. Collating these datasets at a single network entity can be slow and resource intensive, which is problematic for time-critical applications. In addition, some applications require the use of datasets comprising sensitive or private data, and collating these data at a single network entity may have security implications.

Embodiments of the disclosure may address one or more of these and/or other problems.

In one aspect, the disclosure provides a method performed by a first entity in a communications network. The first entity belongs to a plurality of entities configured to perform federated learning to develop a model, each entity of the plurality of entities storing a version of the model, training the version of the model, and transmitting an update for the model to an aggregating entity for aggregation with other updates for the model. The method comprises: training a model using a machine-learning algorithm, and generating a model update comprising updates to values of one or more parameters of the model; generating a first mask; receiving an indication of one or more respective second masks from only a subset of the remaining entities of the plurality of entities, the subset consisting of one or more second entities of the plurality of entities; combining the first mask and the respective second masks to generate a combined mask; applying the combined mask to the model update to generate a masked model update; and transmitting the masked model update to an aggregating entity of the communications network.

In further aspect, the disclosure provides a first entity to perform the method recited above. A further aspect provides a computer program for performing the method recited above. A computer program product, comprising the computer program, is also provided.

Another aspect provides a first entity for a communication network. The first entity belongs to a plurality of entities configured to perform federated learning to develop a model, each entity of the plurality of entities storing a version of the model, training the version of the model, and transmitting an update for the model to an aggregating entity for aggregation with other updates for the model. The first entity comprises processing circuitry and a non-transitory machine-readable medium storing instructions which, when executed by the processing circuitry, cause the first entity to: train a model using a machine-learning algorithm, and generate a model update comprising updates to values of one or more parameters of the model; generate a first mask; receive an indication of one or more respective second masks from only a subset of the remaining entities of the plurality of entities, the subset consisting of one or more second entities of the plurality of entities; combine the first mask and the respective second masks to generate a combined mask; apply the combined mask to the model update to generate a masked model update; and transmit the masked model update to an aggregating entity of the communications network.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows collection of data from network functions;

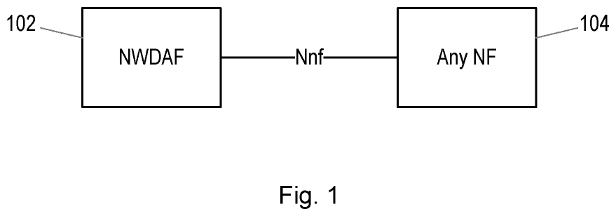

FIG. 2 shows an example of signalling between an NWDAF and a NWDAF Service Consumer;

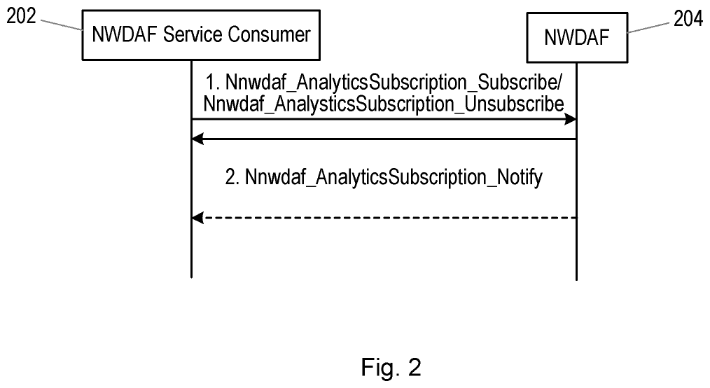

FIG. 3 shows a system according to embodiments of the disclosure;

FIG. 4 is a schematic signalling diagram according to embodiments of the disclosure;

FIG. 5 is a process flow according to embodiments of the disclosure;

FIG. 6 is a flowchart of a method according to embodiments of the disclosure; and

FIGS. 7 and 8 are schematic diagrams showing a network entity according to embodiments of the disclosure.

### DETAILED DESCRIPTION

Embodiments of the disclosure provide methods, apparatus, and machine-readable media for training a model using a machine-learning algorithm. In particular, embodiments of the disclosure relate to collaborative learning between one or more network entities. In particular embodiments, the concept of federated learning is utilized, in which a plurality of network entities train a model based on data samples which are local to the network entities. Thus each network entity generates a respective update to the model, and shares that update with a central, aggregating entity which combines the updates from multiple network entities to formulate an overall updated model. The overall updated model may then be shared with the plurality of network entities for further training and/or implementation. This mechanism has advantages in that the local data (on which each network entity performs training) is not shared with the aggregating entity over the network and thus data privacy is ensured.

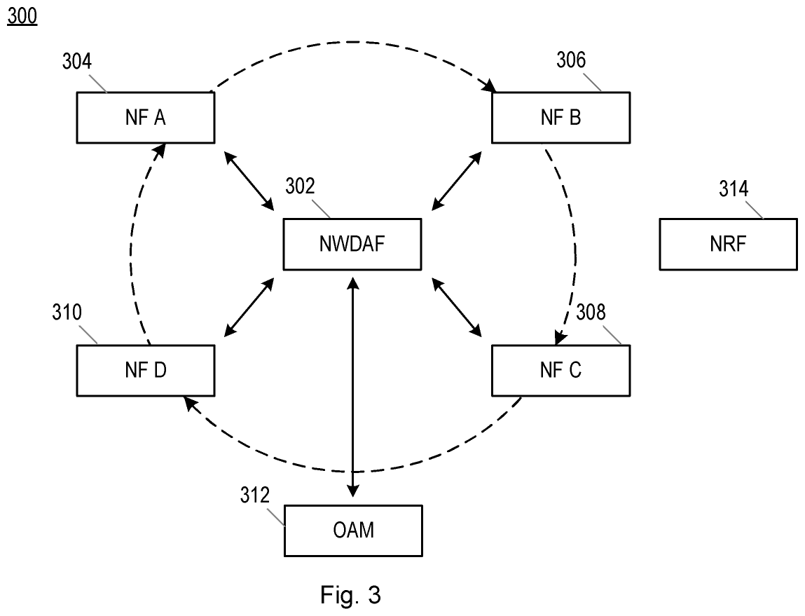

FIG. 3 shows a system 300 according to embodiments of the disclosure, for performing collaborative learning, such as federated learning.

One or more entities of the system may, for example, form part of a core network in the communication network. The core network may be a Fifth Generation (5G) Core Network (SGCN). The communication network may implement any suitable communications protocol or technology, such as Global System for Mobile communication (GSM), Wide Code-Division Multiple Access (WCDMA), Long Term Evolution (LTE), New Radio (NR), WiFi, WiMAX, or Bluetooth wireless technologies. In one particular example, the network forms part of a cellular telecommunications network, such as the type developed by the 3^{rd} Generation Partnership Project (3GPP). Those skilled in the art will appreciate that the system 300 may comprise further components that are omitted from FIG. 3 for the purposes of clarity.

The system 300 comprises an aggregating entity 302, a plurality of network entities or network functions (NFs)—labelled NF A 304, NF B 306, NF C 308 and NF D 310—an operations, administration and maintenance node (OAM) 312 and a NF repository function (NRF) 314. The system 300 may be implemented in a communication network, such as a cellular network comprising a radio access network and a core network. Some of the entities may be implemented in a core network of the communication network.

The system 300 may be partially or wholly implemented in the cloud. For example, one or more of the aggregating entity 302 and the plurality of network functions 304-310 may be implemented virtually (e.g. as one or more virtual network functions).

The system 300 comprises at least two network entities or NFs. In the illustrated embodiment, four network entities are shown, although the skilled person will appreciate that the system 300 may comprise fewer or many more network entities than shown. The network entities 304-310 are configured to provide one or more services. The network entities may be any type or combination of types of network entities or network functions. For example, one or more of the network entities 304-310 may comprise core network entities or functions such as an access and mobility management function (AMF), an authentication server function (AUSF), a session management function (SMF), a policy control function (PCF), and/or a unified data management (UDM) function. Alternatively or additionally, one or more of the network entities 304-310 may be implemented within entities outside the core network, such as radio access network nodes (e.g., base stations such as gNBs, eNBs etc or parts thereof, such as central units or distributed units). The network entities 304-310 may be implemented in hardware, software, or a combination of hardware and software.

Each of the network entities 304-310 is able to communicate with the NWDAF 302. Such communication may be direct, as shown in the illustrated embodiment, or indirect via one or more intermediate network nodes. Each of the network entities 304-310 is further able to communicate with at least one other of the network entities 304-310. In the illustrated embodiment, each network entity 304-310 transmits to a single other network entity, e.g., NF A 304 transmits to NF B 306, NF B 306 transmits to NF C 308, and so on. This leads to a ring configuration, as shown in the illustrated embodiment. Those skilled in the art will appreciate that such a term does not imply any limitations on the physical location (e.g., the geographical location) of the network entities 304, 310. Again, such communication between network entities 304-310 may be direct or indirect. In the latter case, transmissions between the network entities 304-310 may travel via the NWDAF 302 (e.g., in a hub-and-spoke configuration).

Each of the network entities 304-310 is registered at the network registration entity 314 that also forms part of the system 300. In this example, the network registration entity is a Network function Repository Function (NRF) 314. However, the skilled person will appreciate that the network registration entity may be any suitable network entity that provides registration and discovery for network entity services. The NRF 314 may thus store information for each of the network entities 304-310 registered there. The stored information may include one or more of: a type of each of the network entities 304-310; a network address (e.g., IP address) of the network entities; services provided by the network entities; and capabilities of the network entities. Thus, once registered at the NRF 314, the network entities 304-310 are discoverable by other entities in the network.

In one embodiment, the aggregating entity 302 is a network data analytics function (NWDAF). The NWDAF 302 is configured to collect network data from one or more network entities, and to provide network data analytics information to network entities which request or subscribe to receive it. For example, an NWDAF may provide information relating to network traffic or usage (e.g. predicted load information or statistics relating to historical load information). The network data analytics information provided by the NWDAF may, for example, be specific to the whole network, or to part of the network such as a network entity or a network slice. The network data analytics information provided by the NWDAF 308 may comprise forecasting data (e.g. an indication of a predicted load for a network function) and/or historical data (e.g. an average number of wireless devices in a cell in the communication network). The network data analytics information provided by the NWDAF may include, for example, performance information (e.g. a ratio of successful handovers to failed handovers, ratio of successful setups of Protocol Data Unit (PDU) Sessions to failed setups, a number of wireless devices in an area, an indication of resource usage etc.).

As described above, communication networks are becoming increasingly automated, with network designers seeking to minimise the level of human intervention required during operation. One way of achieving this is to use the data collected in communication networks to train models using machine-learning, and to use those models in the control of the communication network. As communication networks continue to obtain data during operation, the models can be updated and adapted to suit the needs of the network. However, as noted above, conventional methods for implementing machine-learning in communication networks require collating data for training models at one network entity. Collating these data at a single network entity, such as the NWDAF 308, can be slow and resource intensive and may be problematic if the data is sensitive in nature.

Aspects of the disclosure address these and other problems.

In one aspect, a collaborative (e.g. federated) learning process is used to train a model using machine-learning. Rather than collating training data for training the model at a single network entity, instances of the model are trained locally at multiple network functions to obtain local updates to parameters of the model at each network entity. The local model updates are collated at the aggregating entity (such as the NWDAF) 302 and combined to obtain a combined model update. In this way, data from across multiple entities in a communication network are used to train a model using machine-learning, whilst minimising resource overhead and reducing security risks.

Accordingly, in the system 300 illustrated in FIG. 3, the NWDAF 302 initiates training of a model using machine-learning at each of the network functions 304-310. For example, the NWDAF 302 may transmit a message to each of the network functions 304-310 instructing the network function to train a model using machine-learning. The message may comprise an initial copy or version of the model (e.g. a global copy that initially is common to each of the network functions 304-310), or each of the network functions 304-310 may be preconfigured with a copy of the model. In the latter case, the message may comprise an indicator of which model is to be trained. The message may specify a type of machine-learning algorithm to be used by the network entities. Alternatively, the network entities 304-310 may be preconfigured with the type of machine-learning algorithm to be used for a model.

On receipt of the message from the NWDAF 302, each network entity 304-310 trains the model by inputting training data into the machine-learning algorithm to obtain a local model update to values of one or more parameters of the model. The training data may be data that is unique to the network entity. For example, the training data may comprise data obtained from measurements performed by the network function and/or data collected by the network function from other network entities (e.g. data obtained from measurements performed by one or more other network entities).

Each of the network entities 304-310 transmits the local model update to the NWDAF 302. The local model update may comprise updated values of the parameters of the model or the local model update may comprise an indication of a change in the values of the parameters of the model, e.g., differences between previous values for the parameters and updated values for the parameters.

Transmissions between the network entities 304-310 and the NWDAF 302 may be direct (e.g. the NWDAF 308 transmits directly to a network entity) or the transmissions may be via an intermediate network entity. For example, the transmission between the network functions 304-310 and the NWDAF 302 may be via an Operation, Administration and Management function (OAM) 312.

The NWDAF 302 thus receives the local model updates from each of the network entities 304-310. The NWDAF 302 combines the model updates received from the network entities 304-310 to obtain a combined model update. The NWDAF 302 may use any suitable operation for combining the model updates. For example, the NWDAF 302 may average the received local model updates to obtain an average model update. In a further example, the average may be a weighted average, with updates from different network entities being assigned different weights.

The NWDAF 302 transmits the combined model update to one or more network entities in the network. For example, the NWDAF 302 may send the combined model update to each of the network entities 304-310. In particular examples, the combined model update may be transmitted to one or more further network entities in addition to the network entities 304-310 used to train the model. The combined model update may comprise updated values of the parameters of the model or an indication of a change in the values of the parameters of the model, e.g., differences between previous values for the parameters and updated values for the parameters.

This process may be repeated one or more times. For example, the process may be repeated until the local model updates received from each of the network entities 304-310 are consistent with each other to within a predetermined degree of tolerance. In another example, the process may be repeated until the combined model updates converge, i.e. a combined model update is consistent with a previous combined model update to within a predetermined degree of tolerance.

Collaborative (e.g. federated) learning may thus be applied to communication networks (and in particular, to a core network in a communication network) to reduce latency, minimise resource overhead and reduce the risk of security problems.

Some aspects of the collaborative learning process described above inherently increase the security of data transmitted over the system 300. For example, security is improved by training local versions of the model at each of the network entities 304-310, as network data (i.e. the data on which the models are trained) is kept local to the respective network entities and not shared widely. Further, the data itself is not aggregated at a single entity, which would otherwise become an attractive point of attack for third parties seeking to gain access to that data. However, conventional collaborative learning, and particularly federated learning, entails the transmission of model updates across the network. A third party which intercepted such updates may be able to use those updates to infer information relating to the training data.

To address this and other problems, embodiments of the disclosure provide methods, apparatus and machine-readable media in which masks are applied to local model updates prior to their transmission from the network entities 304-310 to the aggregating entity 302. Thus each transmitted local model update is masked such that, without knowledge of the respective mask applied to each local model update, the original local model update cannot be recovered by the aggregating entity or any intercepting third party.

The masks may be any suitable quantity which is unpredictable to third parties. For example, the mask may comprise a random or pseudo random string of bits. When applied to the local model update (which itself comprises a string of bits), the values of the local model update are obscured. Many different binary operators may be used to apply the mask to the local model update, such as bit-wise exclusive-OR, or addition. In the case of addition, the mask and the values may be viewed as bit strings; in the case of bit-wise exclusive-OR, the mask and the values may be viewed as integers or floats (for example). In another example, the mask may comprise a random or pseudo random series of numerical values. In this case, any numerical or arithmetic operator may be used to apply the mask to the local model update, such as addition, subtraction, multiplication or division.

Many masks also have another important property, namely that there exists another element, called the inverse in the following, such that the mask and its inverse cancel each other when combined. A concrete example is two integers combined with addition, e.g., the integers 42 and −42 when combined with the addition operator (+) result in the integer 0. Another example is the bit-strings 1010 and 1010, which result in the bit-string 0000 when combined with the bitwise exclusive-OR operator. Thus in some embodiments the masks may have a corresponding inverse that substantially cancels the effect of the mask, e.g., the masks may be invertible.

One way of utilizing this property is for each network entity 304-310 to share their respective masks with the aggregating entity 302. Thus the aggregating entity 302 is able to apply the inverse of the masks to recover the local model updates prior to their combination to obtain the combined model update. The disadvantage of this approach is that the unmasked model updates become available to the aggregating entity 302. If the aggregating entity 302 is not trusted, it should not be able to obtain unmasked data for individual network entities.

To overcome this disadvantage, according to embodiments of the disclosure, masks are shared between the network entities 304-310, with each network entity utilizing a combination of at least two masks to mask its respective local model update. The at least two masks may be combined using many different operators. In one embodiment, the same operator is used to combine the masks as is used to apply the masks to the local model update. The combination of masks used by each network entity 304-310 is configured such that, when the masked local model updates are combined at the aggregating entity 302, the masks cancel each other out.

Consider the following example with respect to the system 300 of FIG. 3. Each network entity generates its own mask, such that NF A 304 generates mask m_{A}, NF B 306 generates mask m_{B}, NF C 308 generates mask m_{C}, and NF D 310 generates mask m_{D}. Each network entity shares its mask with one neighbouring network entity, such that NF A 304 transmits an indication of its mask m_{A} to NF B 306, NF B 306 transmits an indication of its mask m_{B} to NF C 308, and so on. The indications of the masks may be the masks themselves, or a seed which can be expanded into the mask (typically the seed is much smaller than the mask). The indications of the masks may be transmitted directly between the network entities, or indirectly via an intermediate node (such as the NWDAF 302). Each network entity then combines its own mask with the inverse of the mask that it received from its neighbouring entity (or vice versa). For example, the masks may be combined by addition. The network entities then apply their respective combined masks to their respective local model updates. These masked local model updates are combined at the aggregator entity 302 (e.g., through addition, averaging, etc, as described above) and the masks cancel each other as can be seen in the following:

Combined mask at NF A: m_{A} op m_{D}⁻¹

Combined mask at NF B: m_{B} op m_{A}⁻¹

Combined mask at NF C: m_{C} op m_{B}⁻¹

Combined mask at NF D: m_{D} op m_{C}⁻¹

where op is a combining operator (e.g., addition, subtraction, bit-wise exclusive OR, exponentiation, etc), and where m_{A}⁻¹ is the inverse of mask m_{A}, etc.

Masked local model update transmitted by NF A: (m_{A} op m_{D}⁻¹) op v_{A}

Masked local model update transmitted by NF B: (m_{B} op m_{A}⁻¹) op v_{B}

Masked local model update transmitted by NF C: (m_{C} op m_{B}⁻¹) op v_{C}

Masked local model update transmitted by NF D: (m_{D} op m_{C}⁻¹) op v_{D}

where v_{A} is the local model update for NF A 304, etc.

Combined model update at aggregator entity:
[(m_{A} op m_{D}⁻¹) op v_{A}] op [(m_{B} op m_{A}⁻¹) op v_{B}] op [(m_{C} op m_{B}⁻¹) op v_{C}] op [(m_{D} op m_{C}⁻¹) op v_{D}]=v_{A} op v_{B} op v_{C} op v_{D}

Thus the combining operators used for combining the masks, for applying the combined masks to the local model updates, and for combining the masked local model updates may all be the same. The combining operator may also be commutative. The masks cancel with each other and the combined model update is obtained in the same operation. Further, the aggregating entity 302 never becomes aware of any data values from the individual local model updates.

In the example described above, each network entity transmits an indication of its mask to one other network entity. In general, according to embodiments of the disclosure, each network entity shares its mask with a subset of the other network entities taking part in the collaborative learning process. In the system 300 of FIG. 3, for example, each network entity may share its mask with up to two other network entities. Similarly, each network entity may therefore receive indications of masks from up to two other network entities. It will be noted that the subset of network entities to which a network entity transmits its mask may in general be different from the subset of network entities from which the network entity receives masks.

By selecting only a subset of the network entities to receive an indication of the mask, embodiments of the disclosure reduce the signalling overhead associated with the collaborative learning process, while still achieving high levels of security. In particular, it is expected that many network entities may take part in collaborative learning processes and, while it is a straightforward solution for each network entity to share its mask with every other network entity, this will lead to large amounts of traffic on the network. Embodiments of the disclosure instead provide for each network entity sharing its mask with only a subset of the other network entities (e.g., less than all of the network entities other than itself). This provides acceptable levels of security while reducing the signalling overhead.

The number of entities within the subset (e.g. the number of entities to which each network entity transmits an indication of its mask) may be configurable. For example, the number may be configured by the aggregating entity (e.g., the NWDAF 302) or another network entity (e.g., the OAM 312).

It will be noted that where the network receives indications of more than one mask (and correspondingly transmits an indication of its mask to more than one other network entity), each network entity combines three or more separate masks to form the combined mask. In that case, the combination of the masks for all network entities needs to be configured such that the masks do indeed cancel once combined at the aggregator entity.

Each network entity may thus receive a configuration message comprising an indication of the network entities to which it should send an indication of its mask. The indication may comprise one or more of: an identity of the network entities; and addressing information for the network entities. The configuration message may also comprise an indication of the network entities from which it should expect to receive indications of masks (such as an identity of the sending network entities). These indications may alternatively be received in more than one configuration message. The configuration message may be transmitted to the network entities by the aggregating entity 302, the OAM 312 or another network entity or function.

Those skilled in the art will appreciate that many different combinations of masks (and inverses) can be utilized and result in cancellation once combined at the aggregating entity 302. However, the combination of masks does need to be configured to ensure cancellation. Thus, in one embodiment, the configuration message(s) described above may comprise an indication, for each mask, as to whether the mask should be used when combining with the other masks, or its inverse.

In alternative embodiments, the masks may be combined according to some predefined or preconfigured rule. For example, the network entities in the subset may be labelled with a respective index (e.g., in the configuration messages noted above), with those masks associated with network entities having odd indices being inverted, and those masks associated with network entities having even indices not being inverted. Alternative schemes are of course possible.

It was mentioned above that the network entities 304-310 may not in general have direct communication links. Instead, transmissions between network entities (such as the indications of masks) may need to be transferred via the aggregator entity 302.

While the links between the network entities 304-310 and the aggregator entity 302 are typically secured via a security protocol such as Transport Layer Security (TLS) or other means in the 5G service-based architecture, the network entities may not trust the NWDAF 302 not to interfere. For example, if network entities 304-310 were to send their masks, e.g., mₐ and m_{b}, to the NWDAF 302 to be forwarded to the subset of network entities, the NWDAF 302 would learn the masks and could retrieve a value from an expression (−mₐ+m_{b}) op vₐ. For this reason, the network entities 304-310 may encrypt the masks when sending them via the NWDAF 302. The encryption may re-use the certificates operator public key infrastructure (PKI). That is, a network entity sending its mask to a receiving network entity uses the public key of the receiving network entity's certificate to encrypt the mask. Further, to ensure that the NWDAF 302 cannot successfully impersonate network entities towards each other, the masks may also be cryptographically signed.

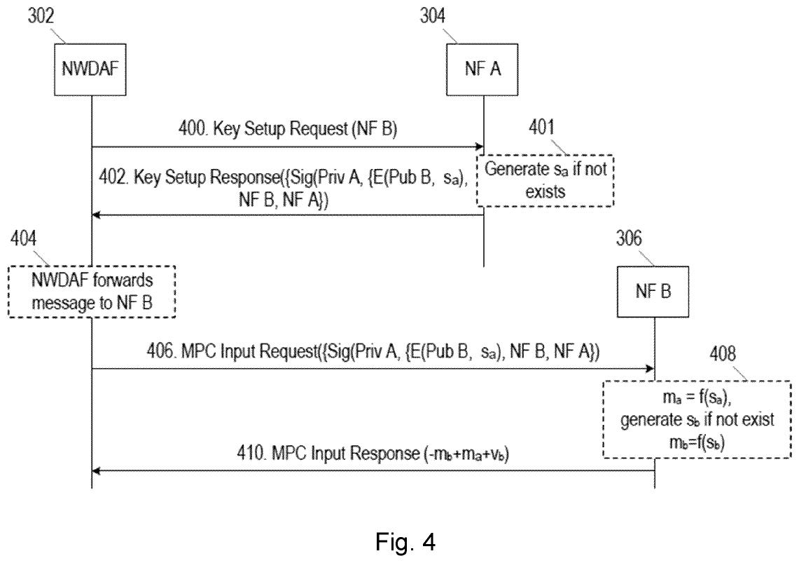

FIG. 4 shows the signaling of a mask from network entity NF A 304 to NF B 306 according to embodiments of the disclosure, particularly where the signaling travels via an intermediate node (such as the NWDAF 302). The signaling can be repeated for transmissions between different network entities.

The first stage of the process is the Key Initialization procedure. In this procedure, the NWDAF 302 sends a Key Setup Request 400 to the NF A 304, indicating a network entity to which NF A 304 should send its mask, i.e., NF B 306 in this example. In step 401, NF A 304 generates a seed sₐ (from which its mask m_{A} can be calculated) unless it has already done so. If the NWDAF 302 has previously run a Multi-Party Computation (MPC) Input Request procedure (see below), NF A 304 should already have generated sₐ.

In step 402, NF A 304 obtains the public key of NF B 306 and encrypts the seed using a public key encryption based system, e.g., EIGamal, RSA, or a hybrid encryption scheme such as ECIES. NF A 304 then signs the encrypted seed sₐ and possibly also its own identifier and the identifier of NF B. Finally, NF A 304 includes this information in a Key Setup Response message 402 and sends it to the NWDAF 302. The notation Sig(Priv A, {x}) is used to indicate that information x is signed using the private key of NF A. Both x and the signature of x are included in the message. NF A 304 may store the seed sₐ for further processing, i.e., for when the NWDAF 304 initiates the MPC Input Request procedure with NF A 304.

The second procedure is the MPC Input Request procedure, in which the aggregator entity 302 (NWDAF) requests local model updates from the network entities, and particularly NF B 306 in the illustrated example. In step 404, the NWDAF 302 forwards the information received in the Key Setup Response 402 to the NF indicated, i.e., NF B 306 in this case. Thus, the NWDAF 302 sends an MPC Input Request message 406 to NF B 306. NF B 306 verifies the signature and decrypts the information.

In step 408, NF B expands the seed sₐ into a longer mask mₐ. This expansion may be performed using an expansion function f, such as a Pseudo Random Function (PRF), a Pseudo Random Generator (PRNG), a Key Derivation Function (KDF), a stream cipher or block-cipher in a stream-generation-mode (like counter mode), where zero, one or more of the inputs are predetermined and known to both NF A 304 and NF B 306. NF B 306 further generates its own seed s_{b} and expands this into a mask m_{b} in the same way as mₐ was expanded. If the NWDAF 302 has previously run the Key Setup Request procedure with NF B 306, NF B would already have generated and stored s_{b} (see above). In that case, NF B would use the stored s_{b} to expand m_{b}. If NF B has not yet been involved in the Key Setup Procedure, it stores the seed s_{b} to be used in that procedure later.

NF B 306 combines the masks mₐ and m_{b} to generate a combined mask, and applies the combined mask to its local model update v_{b}. The MPC Input Response message 410 comprises this masked local model update −m_{b}+mₐ op v_{b}, and is sent to the NWDAF 302 where it is combined with corresponding masked local model updates received from other network entities.

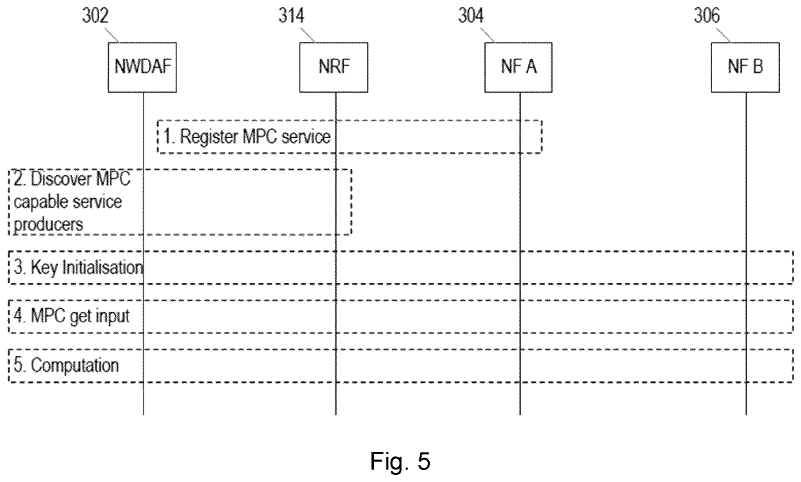

FIG. 5 is a process flow according to embodiments of the disclosure, which shows the overall scheme in which embodiments of the present disclosure may be implemented. The scheme comprises five stages, numbered from 1 to 5.

In the first stage, network entities or functions (such as the network entities 304-310) register with a registration entity (such as the NRF 314). The registration entity stores a profile in respect of each network entity, the profile comprising one or more of: a type of the network entity; one or more services which the network entity is capable of performing (such as collaborative learning, e.g., federated learning); and identity and/or addressing information for the network entity.

In the second stage, the aggregating entity (e.g., the NWDAF 302) communicates with the registration entity to discover network entities which are capable of performing collaborative learning.

In the third stage, the aggregating entity communicates with the network entities selected to be part of the collaborative learning process, to initialise and exchange keys (e.g., public keys for each entity). This stage may also involve the sharing of masks (or seeds) between network entities, e.g., as discussed above with respect to messages and steps 400-402.

In the fourth stage, the network entities transmit masked local model updates to the aggregating entities, e.g., as discussed above with respect to messages and steps 404-410.

In the fifth stage, the aggregating entity combines the received masked local model updates to obtain a combined model update (in which the masks cancel with each other). The aggregating entity may use any suitable operation for combining the model updates. For example, the aggregating entity may average the received local model updates to obtain an average model update. In a further example, the average may be a weighted average, with updates from different network entities being assigned different weights.

The aggregating entity may transmit the combined model update to one or more network entities in the network. For example, the aggregating entity may send the combined model update to each of the network entities 304-310. In particular examples, the combined model update may be transmitted to one or more further network entities in addition to the network entities 304-310 used to train the model.

Stages four and five may be repeated one or more times. For example, they may be repeated until the local model updates received from each of the network entities 304-310 are consistent with each other to within a predetermined degree of tolerance. In another example, the stages may be repeated until the combined model updates converge, i.e. a combined model update is consistent with a previous combined model update to within a predetermined degree of tolerance.

Collaborative (e.g. federated) learning may thus be applied to communication networks to reduce latency, minimise resource overhead and reduce the risk of security problems.

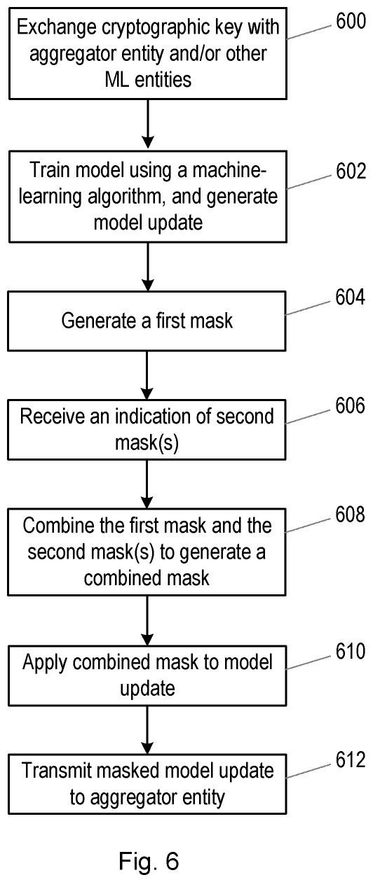

FIG. 6 is a flowchart of a method according to embodiments of the disclosure. The method may be performed by a first network entity, such as one of the plurality of network entities 304-310 described above with respect to FIG. 3. The first network entity belongs to a plurality of network entities configured to participate in a collaborative learning process to train a model, such as federated learning.

In step 600, the first network entity shares its cryptographic key (e.g., a public key) with an aggregating entity (e.g., the NWDAF 302) and/or other network entities belonging to the plurality of network entities. The first network entity may also receive the public keys associated with the aggregating entity and/or other network entities belonging to the plurality of network entities. The public keys for all entities may re-use the public keys from a PKI for the network.

In step 602, the first network entity trains a model using a machine-learning algorithm, and thus generates an update to the model. Embodiments of the disclosure relate to secure methods of sharing these model updates. Thus the particular machine-learning algorithm which is used is not relevant to a description of the disclosure. Those skilled in the art will appreciate that any machine-learning algorithm may be employed to train the model.

Initial parameters for the model, and/or the model structure, may be provided by the aggregator entity (e.g., NWDAF 302) or another network entity. The first network entity trains the model by inputting training data into the machine-learning algorithm to obtain a local model update to values of one or more parameters of the model. The training data may be data that is unique to the network entity. For example, the training data may comprise data obtained from measurements performed by the first network entity and/or data collected by the first network entity from other network entities (e.g. data obtained from measurements performed by one or more other network entities).

The training data may relate to the functioning of the network. For example, the training data may comprise network performance statistics, such as the load being experienced by one or more network nodes or entities (e.g., the number of connected wireless devices, the amount of bandwidth being used by connected wireless devices, the number of services being utilized, etc), the radio conditions being experienced by connected wireless devices (e.g., reported values of signal-to-noise ratio, reference signal received strength or quality, packet drop rate, etc).

The model may be used for various purposes. For example, the model may be a classifier model, trained to detect and classify certain datasets into classifications. For example, the classifier model may identify overload or other fault conditions in the network or parts thereof (e.g., one or more particular network nodes or network slices). The model may be a prediction model, trained to predict future outcomes based on current datasets. For example, the prediction model may predict future overload or other fault conditions in the network or parts thereof.

The update to the model may comprise new values for one or more parameters of the model (e.g., new weights for a neural network, etc), or changes to the values for one or more parameters of the model (e.g., differences between the earlier values and the trained values for those parameters).

In step 604, the first network entity generates a first mask, which is associated with the first network entity. The first mask may be any suitable quantity which is unpredictable to third parties. For example, the first mask may comprise a random or pseudo random string of bits. In another example, the first mask may comprise a random or pseudo random series of numerical values. The mask may be invertible.

The first mask may be generated by first generating a seed (e.g., a smaller string of bits or values), and then expanding the seed using an expansion function to generate the first mask. This expansion may be performed using an expansion function, such as a Pseudo Random Function (PRF), a Pseudo Random Generator (PRNG), a Key Derivation Function (KDF), a stream cipher or block-cipher in a stream-generation-mode (like counter mode), where zero, one or more of the inputs are predetermined and known to the first network entity.

In step 606, the first network entity receives an indication of one or more second masks from one or more second network entities belonging to the plurality of network entities. For example, the first network entity may receive an MPC Input Request message 408 such as that described above with respect to FIG. 4. The one or more second entities form a subset of the network entities other than the first network entity. The indication may comprise the one or more second masks themselves, or seeds which can be expanded into the second masks using an expansion function as described above.

The indication may be received directly from the one or more second masks (e.g., separate indications for each second mask), or indirectly from the aggregator entity. In the latter case, the indication may be encrypted with the first entity's public key, shared with the second network entities in step 600 described above. See FIG. 4 for more information on this aspect.

Although not illustrated in FIG. 6, the method may further comprise transmitting an indication of the first mask to one or more third entities of the plurality of network entities (e.g., as described above with respect to Key Setup Response message 402). The one or more third entities form a subset of the network entities other than the first network entity. The first network entity may receive an indication of the third network entities (e.g., identity information and/or addressing information) from the aggregator entity (e.g., the NWDAF 302) or another network node (such as the OAM 312). In further embodiments the aggregating entity or other network node may configure the number of network entities in the subset, with the network entities themselves determining which network entities to share their masks with. For example, the aggregating entity or other network node may share addressing or identity information of all network entities which are configured to train a particular model, with those network entities. Thus each network entity becomes aware of the other network entities which are training the model. The network entities may then communicate with each other to identify suitable subsets and/or mask combination strategies (e.g., whether or not a mask is to be inverted prior to combination with one or more other masks). The number of network entities in the subset may be defined by the aggregating entity or other network node, or by the network entities themselves (e.g., through being pre-configured with that information).

In step 608, the first network entity combines the first mask with the one or more second masks. The masks may be combined using many different operations, such as addition, subtraction, bit-wise exclusive OR, exponentiation, etc. The operations may be commutative. At least one of the first mask and the one or more second masks may be inverted prior to combination in step 608, such that, when the masked local model updates from all network entities are combined, the masks cancel with each other.

In step 610, the first network entity applies the combined mask generated in step 608 to the local model update generated in step 602. Again, many suitable combining operators may be implemented for this purpose. In one embodiment, the same combining operator is used in both steps 608 and 610. For example, where the mask comprises a bit string, any binary operator may be used to apply the mask to the local model update, such as bit-wise exclusive-OR, or addition. Where the mask comprises a string of numerical values, any numerical or arithmetic operator may be used to apply the mask to the local model update, such as addition, subtraction, multiplication, division or exponentiation.

In step 612, the masked model update is transmitted to the aggregator entity, where it is combined with other masked model updates.

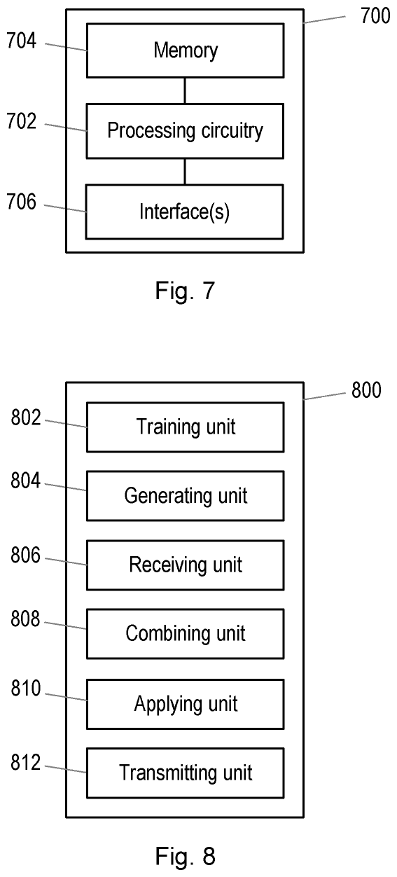

FIG. 7 is a schematic block diagram of an apparatus 700 in a communication network (for example, the system 300 shown in FIG. 3). The apparatus may be implemented in a network entity or function (such as one of the network functions, 304, 306, 308, 310 described above with respect to FIG. 3). In particular examples, the apparatus 700 may be implemented virtually. For example, the apparatus 700 may be implemented in a virtual network entity or function.

Apparatus 700 is operable to carry out the example method described with reference to FIG. 6 and possibly any other processes or methods disclosed herein. It is also to be understood that the method of FIG. 6 may not necessarily be carried out solely by apparatus 700. At least some operations of the method can be performed by one or more other entities.

The apparatus 700 may belong to a plurality of entities configured to perform federated learning to develop a model. Each entity of the plurality of entities stores a version of the model, trains the version of the model, and transmits an update for the model to an aggregating entity for aggregation with other updates for the model.

The apparatus 700 comprises processing circuitry 702, a non-transitory machine-readable medium (e.g., memory) 704 and, in the illustrated embodiment, one or more interfaces 706. In one embodiment, the non-transitory machine-readable medium 704 stores instructions which, when executed by the processing circuitry 702, cause the apparatus 700 to: train a model using a machine-learning algorithm, and generating a model update comprising updates to values of one or more parameters of the model; generate a first mask; receive an indication of one or more respective second masks from only a subset of the remaining entities of the plurality of entities, the subset consisting of one or more second entities of the plurality of entities; combine the first mask and the respective second masks to generate a combined mask; apply the combined mask to the model update to generate a masked model update; and transmit the masked model update to an aggregating entity of the communications network.

In other embodiments, the processing circuitry 702 may be configured to directly perform the method, or to cause the apparatus 700 to perform the method, without executing instructions stored in the non-transitory machine-readable medium 704, e.g., through suitably programmed dedicated circuitry.

FIG. 8 illustrates a schematic block diagram of an apparatus 800 in a communication network (for example, the system 300 shown in FIG. 3). The apparatus may be implemented in a network entity or function (such as one of the network functions, 304, 306, 308, 310 described above with respect to FIG. 3). In particular examples, the apparatus 800 may be implemented virtually. For example, the apparatus may be implemented in a virtual network entity or function.

Apparatus 800 is operable to carry out the example method described with reference to FIG. 6 and possibly any other processes or methods disclosed herein. It is also to be understood that the method of FIG. 6 may not necessarily be carried out solely by apparatus 800. At least some operations of the method can be performed by one or more other entities.

Apparatus 800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause training unit 802, generating unit 804, receiving unit 806, combining unit 808, applying unit 810 and transmitting unit 812, and any other suitable units of apparatus 800 to perform corresponding functions according one or more embodiments of the present disclosure.

The apparatus 800 may belong to a plurality of entities configured to perform federated learning to develop a model. Each entity of the plurality of entities stores a version of the model, trains the version of the model, and transmits an update for the model to an aggregating entity for aggregation with other updates for the model.

As illustrated in FIG. 8, apparatus 800 includes training unit 802, generating unit 804, receiving unit 806, combining unit 808, applying unit 810 and transmitting unit 812. Training unit 802 is configured to train a model using a machine-learning algorithm, and generating a model update comprising updates to values of one or more parameters of the model. Generating unit 804 is configured to generate a first mask. Receiving unit 806 is configured to receive an indication of one or more respective second masks from only a subset of the remaining entities of the plurality of entities, the subset consisting of one or more second entities of the plurality of entities. Combining unit 808 is configured to combine the first mask and the respective second masks to generate a combined mask. Applying unit 810 is configured to apply the combined mask to the model update to generate a masked model update. Transmitting unit 812 is configured to transmit the masked model update to an aggregating entity of the communications network.

Both apparatuses 700 and 800 may additionally comprise power-supply circuitry (not illustrated) configured to supply the respective apparatus 700, 800 with power.

The embodiments described herein therefore allow for reducing latency, minimising resource overhead and reducing the risk of security problems when implementing machine-learning in communication networks. In particular, the embodiments described herein provide a secure method for sharing updates to a model developed using a collaborative learning process, thereby reducing the ability for third parties to gain access to the contents of the model and/or the data used to train the model.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

It should be noted that the above-mentioned embodiments illustrate rather than limit the concepts disclosed herein, and that those skilled in the art will be able to design many alternative embodiments without departing from the scope of the appended following statements. The word “comprising” does not exclude the presence of elements or steps other than those listed in a statement, “a” or “an” does not exclude a plurality, and a single processor or other unit may fulfil the functions of several units recited in the statements. Any reference signs in the statements shall not be construed so as to limit their scope.

1. A method performed by a first entity in a communications network, the first entity belonging to a plurality of entities configured to perform federated learning to develop a model, each entity of the plurality of entities storing a version of the model, training the version of the model, and transmitting an update for the model to an aggregating entity for aggregation with other updates for the model, the method comprising:
training a model using a machine-learning algorithm, and generating a model update comprising updates to values of one or more parameters of the model;
generating a first mask;
receiving an indication of one or more respective second masks from only a subset of the remaining entities of the plurality of entities, the subset consisting of one or more second entities of the plurality of entities;
transmitting an indication of the first mask to one or more third entities of the plurality of entities;
combining the first mask and the respective second masks to generate a combined mask;
applying the combined mask to the model update to generate a masked model update; and
transmitting the masked model update to an aggregating entity of the communications network.

2. The method according to claim 1, further comprising receiving an indication of the one or more third entities.

3. The method according to claim 1, further comprising:
receiving an indication of a number of the one or more third entities; and
selecting, from the plurality of entities, the one or more third entities.

4. The method according to claim 2, wherein the indication of the one or more third entities, or the indication of the number of the one or more third entities is received from the aggregating entity or another network entity.

5. The method according to claim 1, wherein the indication of the first mask is encrypted with a cryptographic key associated with the one or more third entities.

6. The method according to claim 5, wherein the indication of the first mask is transmitted to the one or more third entities via the aggregating entity, and wherein the indication is further encrypted with a cryptographic key associated with the aggregating entity.

7. The method according to claim, wherein combining the first mask and the second masks comprises combining the first mask and an inverse of the second masks, or combining an inverse of the first mask and the second masks

8. The method according to claim 1, wherein the first mask and the one or more second masks each comprise a bit mask, and wherein the first mask and the second masks are combined using a binary operator.

9. The method according to claim 8, wherein the binary operator comprises an exclusive-OR operator.

10. The method according to claim 1, wherein the first mask and the one or more second masks each comprise numerical values, and wherein the first mask and the second masks are combined using an addition operation.

11. The method according to claim 1, wherein:
the indication of the one or more second masks comprises the one or more second masks; or
the indication of the one or more second masks comprises one or more seeds, and wherein the method further comprises generating the one or more second masks by applying an expansion function to the one or more seeds.

12. The method according to claim 1, wherein the indication of one or more respective second masks is received from the aggregating entity or directly from the one or more second entities.

13. The method according to claim 1, wherein the indication of one or more respective second masks is encrypted using a public key of the first entity.

14. The method according to claim 1, wherein the model update comprises:
differential values between an initial version of the model and a trained version of the model; or
values for a trained version of the model.

15. The method according to claim 1, wherein one or more of the following apply:
the plurality of entities comprise a plurality of network functions in a core network of the communications network; and
the aggregating entity comprises a Network Data Analytics Function, NWDAF.

16. A first entity for a communication network, configured to perform the method according to claim 1.

17. A first entity for a communication network, the first entity belonging to a plurality of entities configured to perform federated learning to develop a model, each entity of the plurality of entities storing a version of the model, training the version of the model, and transmitting an update for the model to an aggregating entity for aggregation with other updates for the model, the first entity comprising processing circuitry and a non-transitory machine-readable medium storing instructions which, when executed by the processing circuitry, cause the first entity to:
train a model using a machine-learning algorithm, and generate a model update comprising updates to values of one or more parameters of the model;
generate a first mask;
receive an indication of one or more respective second masks from only a subset of the remaining entities of the plurality of entities, the subset consisting of one or more second entities of the plurality of entities;
transmit an indication of the first mask to one or more third entities of the plurality of entities;
combine the first mask and the respective second masks to generate a combined mask;
apply the combined mask to the model update to generate a masked model update; and
transmit the masked model update to an aggregating entity of the communications network.

18-33. (canceled)

34. A method performed by a system in a communications network, the system comprising an aggregating entity and a plurality of entities configured to perform federated learning to develop a model, the method comprising, at each entity in the plurality of entities:
training a model using a machine-learning algorithm, and generating a model update comprising updates to values of one or more parameters of the model;
generating a first mask;
receiving an indication of one or more respective second masks from only a subset of the remaining entities of the plurality of entities, the subset consisting of one or more second entities of the plurality of entities;
transmitting an indication of the first mask to one or more third entities of the plurality of entities;
combining the first mask and the respective second masks to generate a combined mask;
applying the combined mask to the model update to generate a masked model update; and
transmitting the masked model update to an aggregating entity of the communications network, wherein the method further comprises, at the aggregating entity:
combining the masked model updates received from the plurality of entities.

35. A system in a communications network, the system comprising an aggregating entity and a plurality of entities configured to perform federated learning to develop a model, wherein each entity in the plurality of entities is configured to:
train a model using a machine-learning algorithm, and generating a model update comprising updates to values of one or more parameters of the model;
generate a first mask;
receive an indication of one or more respective second masks from only a subset of the remaining entities of the plurality of entities, the subset consisting of one or more second entities of the plurality of entities;
transmit an indication of the first mask to one or more third entities of the plurality of entities;
combine the first mask and the respective second masks to generate a combined mask;
apply the combined mask to the model update to generate a masked model update; and
transmit the masked model update to an aggregating entity of the communications network, wherein the aggregating entity is configured to:
combine the masked model updates received from the plurality of entities.
